(19) United States
(12) Patent Application Publication
(10) Pub. No.: US 2006/0051541 A1
(43) Pub. Date: Mar. 9, 2006

(54) Polymeric preform for a blow molded plastic article

(76) Inventor: Scott W. Steele, Perrysburg, OH (US)

Correspondence Address: KUDIRKA & JOBSE, LLP, ONE STATE STREET, SUITE 800, BOSTON, MA, 02109, US

(21) Appl. No.: 10/938,023

(22) Filed: Sep. 9, 2004

(51) Int. Cl. B32B 27/08; B29C 49/00

(52) U.S. Cl. 428/35.7; 264/319; 264/523

(57) ABSTRACT

A polymeric preform that can be blow molded into a plastic article includes an open neck portion, a body portion with a sidewall, and a closed end opposite the neck portion with a thickness of not more than 70 percent of the thickness of the sidewall. The thickness of the closed end is preferably in the range of 30 percent to 70 percent of the thickness of the sidewall, and more preferably between 30 percent to 50 percent of the sidewall thickness. This reduces the volume or amount of material needed to form the preform without adversely impacting the structural integrity or physical properties of a container formed from the preform. According to one presently preferred aspect of the invention, the preform is compression molded.

### FIELD OF THE INVENTION

The present invention relates generally to molded plastic articles and more particularly to a polymeric preform for molding plastic articles.

### BACKGROUND OF THE INVENTION

Plastic articles have been formed by blow molding plastic preforms into a desired final shape, such as a plastic bottle or container. The preform typically includes a body having an open end or mouth and a closed end. A cylindrical finish with external threads has been provided at the open end of the preform to facilitate handling and further processing of the preform, and to facilitate forming a blow molded article with external threads to, for example, receive a closure.

Plastic preforms used in blow molding plastic articles have been formed by injection molding. In the injection molding process the molten plastic material is injected through a gate into a mold cavity wherein the preform is permitted to cool, cure or set sufficiently for subsequent handling and/or processing of the preform. To facilitate mold filing of the polymeric material within the injection molding cavity, the gate has been provided co-axially aligned with the preform body generally in the center of the closed lower end of the preform. To ensure sufficient material flow in the cavity, the thickness of the cavity in the area of the gate must be relatively large resulting in a plastic preform with a relatively thick lower or closed end.

### SUMMARY OF THE INVENTION

A polymeric preform that can be blow molded into a plastic article includes an open neck portion, a body portion with a sidewall, and a closed end opposite the neck portion with a thickness of not more than 70 percent of the thickness of the sidewall. The thickness of the closed end is preferably in the range of 30 percent to 70 percent of the thickness of the sidewall, and more preferably between 30 percent to 50 percent of the sidewall thickness. According to one presently preferred aspect of the invention, the preform is compression molded.

Providing a closed end that is thinner than the sidewall reduces the volume or amount of material needed to form the preform without adversely impacting the structural integrity or physical properties of a container formed from the preform. Accordingly, preforms and containers can be formed more efficiently, at lower cost, and with improved design freedom.

### BRIEF DESCRIPTION OF THE DRAWINGS

These and other objects, features and advantages of the present invention will be apparent from the following detailed description of the preferred embodiments and best mode, appended claims and accompanying drawings in which:

FIG. 1 is a perspective view of one presently preferred embodiment of a preform used in blow molding plastic articles;

FIG. 2 is a cross-sectional view of the preform of FIG. 1;

FIG. 3 is an elevational view of a generic container such as may be formed from a preform as shown in FIGS. 1 and 2; and

FIG. 4 is a fragmentary sectional view of a portion of an alternate embodiment of a preform.

### DETAILED DESCRIPTION OF THE PREFERRED EMBODIMENTS

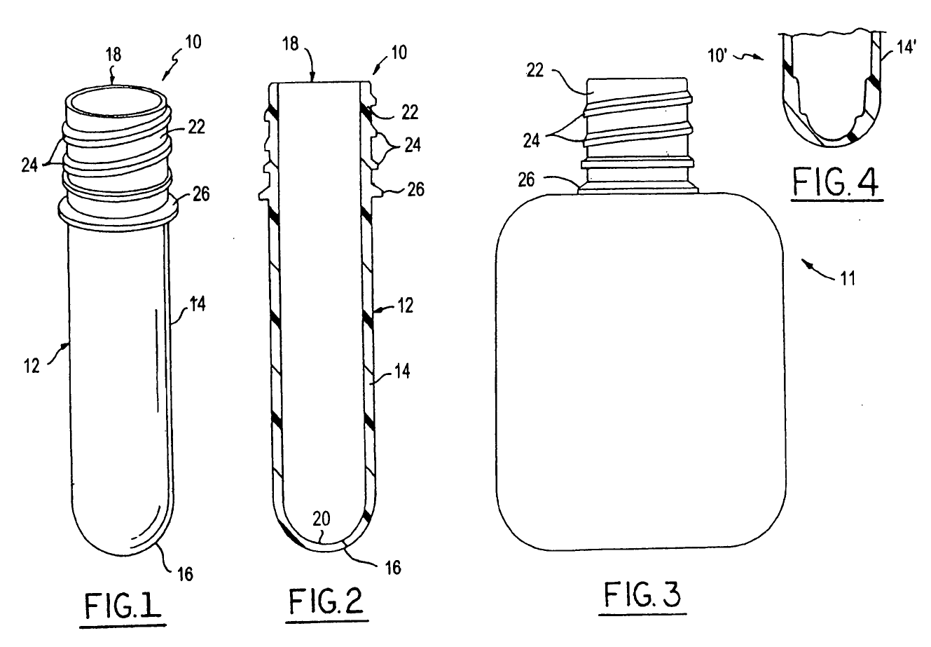

Referring in more detail to the drawings, FIGS. 1 and 2 illustrate a molded polymeric preform 10 that is used to form a plastic article, such as a plastic bottle or container. In one presently preferred embodiment, the preform 10 is formed by compression molding and is subsequently blow molded into a plastic article, such as a container 11 (FIG. 3). Representative and presently preferred apparatus and method for compression molding preforms are shown and described in U.S. patent application Ser. No. (OI 18282), the disclosure of which is incorporated herein by reference in its entirety. The preform 10 can be made from a wide variety of materials, such as polyethylene terephthalate (PET), and may be of single or multi-layer construction.

The preform 10 preferably includes a body 12 having a sidewall 14 that is closed at one end 16 and is open at its other end 18. The closed end 16 of the preform 10 is preferably generally hemispherical or otherwise formed providing a generally concave inner surface 20. Adjacent to the open end 18 of the preform 10, a neck finish 22 is preferably provided and may include one or more external threads 24 adapted, for example, to receive a closure in the example where the preform 10 is subsequently formed into a plastic container, such as the generic container 11 shown in FIG. 3. Axially spaced from the threads 24, a radially outwardly extending flange 26 may be provided to facilitate handling the preform 10 or for other reasons.

The sidewall 14 of the preform 10 is preferably of substantially uniform thickness and is generally cylindrical and circumferentially continuous. In one presently preferred embodiment, the thickness of the sidewall 14 is between 2.5 and 5 millimeters, more preferably between 3 to 4 millimeters although substantially any thickness and size of preform 10 may be used.

As best shown in FIG. 2, the closed end 16 of the preform 10 preferably has a generally semi-spherical shape and a thickness that is less than the thickness of the sidewall 14. Preferably, the thickness of the closed end 16 is not more than seventy (70) percent of the thickness of the sidewall 14. In one presently preferred embodiment, the thickness of the closed end 16 is in the range of thirty (30) percent to seventy (70) percent of the thickness of the sidewall 14, and more preferably between thirty (30) percent to fifty (50) percent of the sidewall thickness. In at least some applications, the closed end 16 of the preform 10 is not stretched as much as sidewall 14 during a subsequent blow molding operation to form the preform 10 into a plastic container so the closed end 16 of the preform 10 can be thinner.

Preforms used to form plastic containers or bottles are commonly formed from PET. The preform design affects the final material distribution of the container or bottle 11, the material properties, and many other characteristics. In forming at least some preforms into plastic articles such as containers or bottles, a stretch blow molding process is used. In such a process, a stretch rod is disposed in the blow mold cavity and used to simultaneously stretch the preform 10 as it is inflated with air. The stretch rod typically engages the end wall 20 or bottom of the preform 10, and the forces imparted by the stretch rod must be taken into account when designing a preform 10. Also, in injection molded preforms, the area of the preform at the injection molding gate is typically the weakest portion of the preform due to molded in stress and crystallinity in that area. This last mentioned issue is not encountered in compression molded preforms which do not have a weak gate area and can be formed more uniform in strength and material properties.

To facilitate stretch blow molding a preform 10 with a thinner closed end 16 as set forth herein, the preform 10 can be unevenly heated so that the material in the area of the closed end 16 is cooler than surrounding material in the preform sidewall 14 to improve the strength and integrity of the closed end 16 during the stretching and blowing process. This can improve the ability of the preform 10 to withstand and support the force of the stretching rod.

While certain preferred embodiments and constructions and arrangements of the preform 10 have been shown and described herein, one of ordinary skill in this art will readily understand that modifications and substitutions can be made without departing from the spirit and scope of the invention as defined by the appended claims. For example, while the sidewall 14 has been shown to be of uniform thickness along its axial length, the sidewall thickness could be non-uniform as shown in FIG. 4. In such a construction, the thickness of the closed end 16 would be not more than 70 percent of the thickest portion of the sidewall. Also, while a generic container 11 that may be formed from a preform 10 as set forth herein is shown in FIG. 3, containers or plastic articles of substantially any size or shape can be formed from such preforms 10, as desired for particular applications. Likewise, the preform 10 may be of substantially any shape and is not limited to having a cylindrical body with a generally hemispherical closed end. Of course, other modifications and substitutions will be apparent from the detailed description of the presently preferred embodiment.

1. A method of making a preform for blow molding a plastic container, which includes compression molding a preform to have an open neck portion, a body portion with a sidewall and a closed end with a thickness of not more than 70% of the thickness of said sidewall.

2. The method set forth in claim 1 wherein the thickness of the closed end is in the range of 30% to 70% of the thickness of the sidewall.

3. The method set forth in claim 2 wherein the thickness of the closed end is in the range of 30% to 50% of the thickness of the sidewall.

4. The method set forth in claim 1 wherein the sidewall has a non-uniform thickness along its axial extent and thickness of the closed end is in the range of 30% to 70% of the thickest portion of the sidewall.

5. The method set forth in claim 4 wherein the thickness of the closed end is in the range of 30% to 50% of the thickest portion of the sidewall.

6. A polymeric preform that can be blow molded into a plastic article includes a body having a sidewall, an open end and a closed end at an end of the sidewall opposite to the open end, the thickness of the closed end being not more than 70% of the thickness of the sidewall.

7. The preform set forth in claim 6 wherein the thickness of the closed end is in the range of 30% to 70% of the thickness of the sidewall.

8. The preform set forth in claim 7 wherein the thickness of the closed end is in the range of 30% to 50% of the thickness of the sidewall.

9. The preform set forth in claim 6 wherein the sidewall has a non-uniform thickness along its axial extent and thickness of the closed end is in the range of 30% to 70% of the thickest portion of the sidewall.

10. The preform set forth in claim 9 wherein the thickness of the closed end is in the range of 30% to 50% of the average thickness of the sidewall.

11. A compression molded preform as set forth in claim 6.

12. The preform set forth in claim 6 wherein the thickness of the sidewall is between 2.5 and 5 millimeters.

13. The preform of claim 12 wherein the thickness of the closed end is between 0.75 and 3.5 millimeters.

14. The preform set forth in claim 6 wherein the thickness of the sidewall is between 3 and 4 millimeters.

15. The preform of claim 14 wherein the thickness of the closed end is between 0.9 and 2.8 millimeters.
